(19) United States
(12) Patent Application Publication
(10) Pub. No.: US 2013/0300141 A1
(43) Pub. Date: Nov. 14, 2013

(54) Carrying aid equipped with thumbhole and button snap fastener to permit transporting and swiveling of a portable touch screen device

(71) Applicant: Derrick Thomas Byrne, Poughkeepsie, NY (US)

(72) Inventor: Derrick Thomas Byrne, Poughkeepsie, NY (US)

(21) Appl. No.: 13/466,728

(22) Filed: May 8, 2012

(51) Int. Cl. B65G 7/12

(52) U.S. Cl. 294/25

(57) ABSTRACT

A strap or glove wraps around the palm and back of a wearer's hand. The wearer's thumb protrudes through a thumbhole in the strap or glove. A button snap fastener is secured to the strap or glove and mates with a complementary button snap fastener on a casing of a portable touch screen device to permit swivel of the portable touch screen device by 360 degree rotation about the palm of the wearer.

### BACKGROUND OF THE INVENTION

1. Field of the Invention

The present invention relates to a carrying aid in the form of an accessory for a portable touch screen device that is useful to retain the portable touch screen device upon the accessory wearer's hand yet allowing for full 360 degree rotation or swivel of the portable touch screen device relative to the accessory wearer's hand. Such an accessory may be in the form of a strap or thumbless glove equipped with a thumbhole through which passes a thumb of the wearer to secure the strap about the accessory wearer's hand under tension. The accessory is equipped with a metallic button snap fastener which, when snapped into a complementary metallic button snap fastener on a back cover of the portable touch screen, allows the portable touch screen to swivel or rotate a full 360 degrees.

2. Discussion of Related Art

The idea for this invention was conceived when I was using my Tablet device (a portable touch screen device) and realized that users with smaller hands may have a difficult time holding the Tablet device properly. Also, users with larger hands may touch part of the screen while operating and may cause issues with multiple touch points on the Tablet device. The proper way to hold the Tablet device depends on the function being completed. If the Tablet device is landscape orientation for web browsing, most Tablet devices are too large to get a grip and the user may hold the Tablet device from one corner. With the Tablet device being held from a corner it does not give a stable surface to interact with. If the Tablet device is in portrait mode, the user should hold the Tablet device with their thumb on one side and grip with their other fingers on opposite side. This orientation becomes a problem due to different sizes of Tablet devices as well as the size of the users' hand. The Tablet device may also heat up due to long term use and can get uncomfortable when holding directly in hand.

There is an ASUS Transformer 360 Rotation case under model no. TF101 designed to look like a high-quality day planner. The case is made of soft, yet durable leatherette material and comes in either black or brown. The case consists of two sections:
Outer section looks like a day planner and can be closed with an attractive elastic band
Inner section attaches to the outer section with a durable metallic button snap that allows the inner case to spin 360 degrees

This allows the owner to adjust the screen to horizontal or vertical viewing without having to turn the entire case. The inner case has openings for all connections on the TF101 to include the memory slot and attachment to the ASUS keyboard without needing to remove the tablet from the case. If one needs to shoot a quick picture, simply unsnap the inner case to provide full access to both cameras. Three slots are provided to allow viewing the tablet from multiple angles.

I found such a conventional rotation case to be awkward to handle for using a personal touch screen device in the palm of my hand because the outer section serves as an undesirable barrier between the palm and the personal touch screen device when held. That is, such a barrier prevents one from grasping the personal touch screen device directly because of its size, rigidity and bulk.

The conventional rotation case needs to have some rigidity since it serves as a stand in a folded condition for the personal touch screen device when swiveled into position. The conventional rotation case needs to have some bulk to help protect the personal touch screen device to some extent against breakage when being stored inside and not in use.

It is desired to provide a carrying accessory for a personal touch screen device that allows the wearer to both grasp the personal touch screen device with the wearer's fingers and yet allow the personal touch screen device to swivel or rotate in the palm of the wearer's hand.

### SUMMARY OF THE INVENTION

The intended purpose of this invention is to act as a carrying aid for transporting and using a Tablet or other portable touch screen device. This invention includes a strap or glove, which will attach to a Tablet or other device by a button snap to allow for full 360° rotation or swivel.

### BRIEF DESCRIPTION OF THE DRAWING

FIG. 1 shows a top view of a buckle strap accessory for a personal touch screen device in accordance with a first embodiment of the invention.

FIG. 2 shows an edge view of the accessory of FIG. 1 with its ends being brought together and with its female button snap fastener being urged in a direction to make engagement with a male button snap fastener on a protective case of a personal touch screen device.

FIG. 3 shows a top view of a hook and loop strap accessory for a personal touch screen device in accordance with a second embodiment of the invention.

FIG. 4 shows an edge view of the accessory of FIG. 3 with its ends being brought together and with its female button snap fastener being urged in a direction to make engagement with a male button snap fastener on a protective case of a personal touch screen device.

FIG. 5 shows an isometric view of the accessory of either the first embodiment of FIGS. 1-2 or the second embodiment of FIGS. 3-4 wrapped around the palm and back of the hand of a wearer whose thumb protrudes through a thumb hole with the male and female button snap fasteners secured to each other to permit swivel movement about the button snap fasteners.

### DESCRIPTION OF THE PREFERRED EMBODIMENT

The invention is similar to that of hand strap on the back of scanning devices in retail and warehouse operation, except this will have rotation capabilities and can be used on any portable device.

Since many institutions are using these devices for everyday operations, such as hospitals, universities, warehouses, and retailers; this invention will provide accessibility, portability and increase functionality of such device.

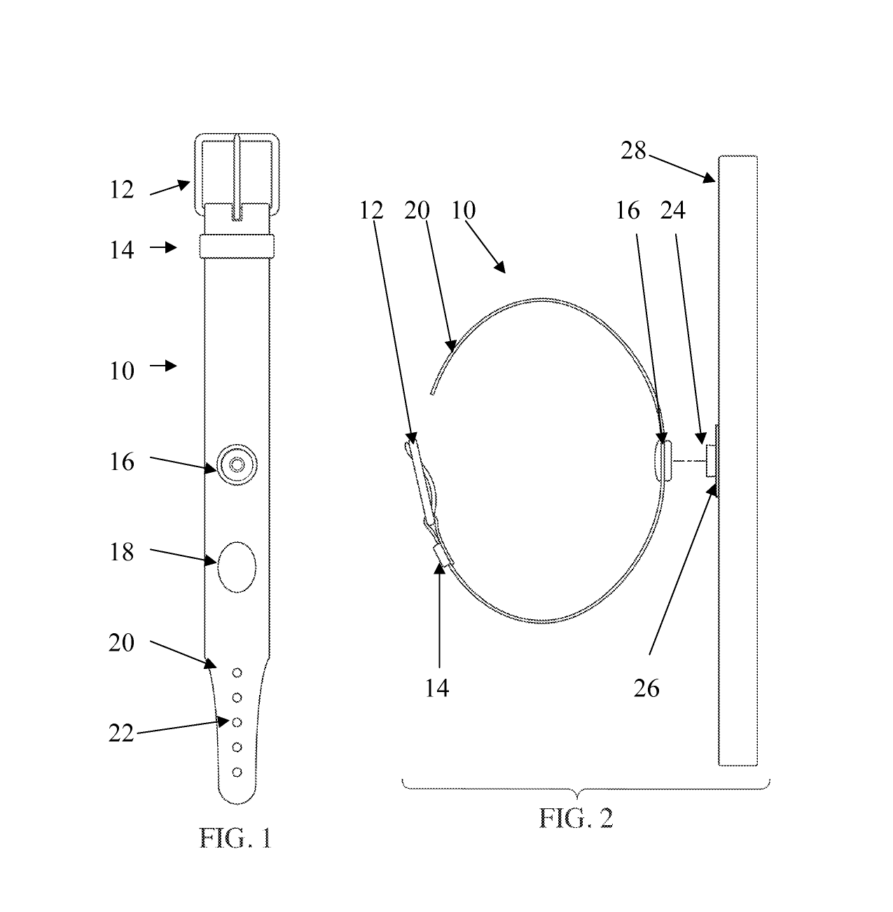

Turning to the drawing, FIGS. 1-5 depict a carrying aid for transporting and swiveling a portable touch screen device in the palm of a wearer's hand.

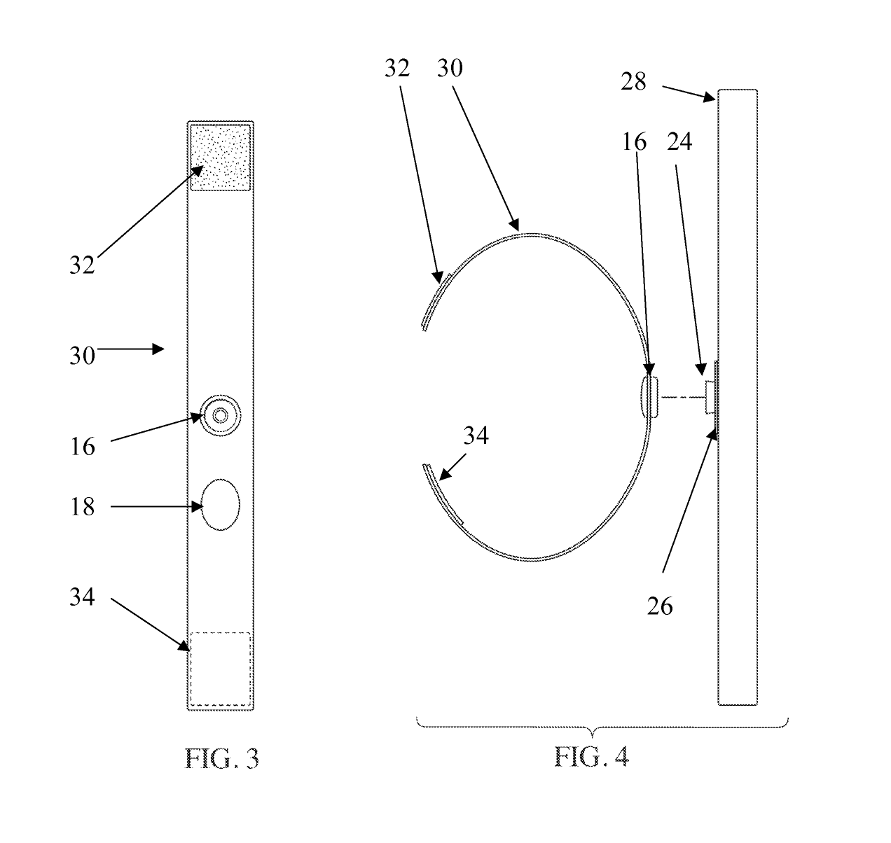

FIG. 1 shows the carrying aid as an accessory 10 in accordance with a first embodiment and FIG. 3 shows the carrying aid as an accessory 30 in accordance with a second embodiment. With the exception of the manner of fastening their free ends together, the two accessories 10, 30 are the same—each is a strap.

The strap in accordance with my invention is made of a durable, non-elastic material such as Nylon about 10″ long and 1 inch wide. The strap will have a female button snap 16 (that may be located on a moveable loop) and a thumb hole 18 for insertion by a thumb about an inch in from one end.

In accordance with FIG. 1, attached at one end will be a 2½″ leather watch strap 20 with several small holes 22 for adjustable operation. At the other end of the strap will be a ½″ buckle 12 and a retaining loop 14 that accommodates insertion of the watch strap 20 after it passes through the buckle 12 and a buckle prong enters into an appropriate one of the small holes 22 to fit the strap wrapped around the palm and back of the hand of the wearer. The strap will close in the same fashion as does a wristwatch buckle belt or a clothing belt. The small holes 22 are each smaller in dimension than the thumbhole 18.

In accordance with FIG. 3, attached at each end on opposite faces will be hook and loop fasteners 32, 34 in place of the buckle 12 and watch strap 20 of FIG. 1. The strap will close by engaging the hook and loop fasteners 32, 34 with each other.

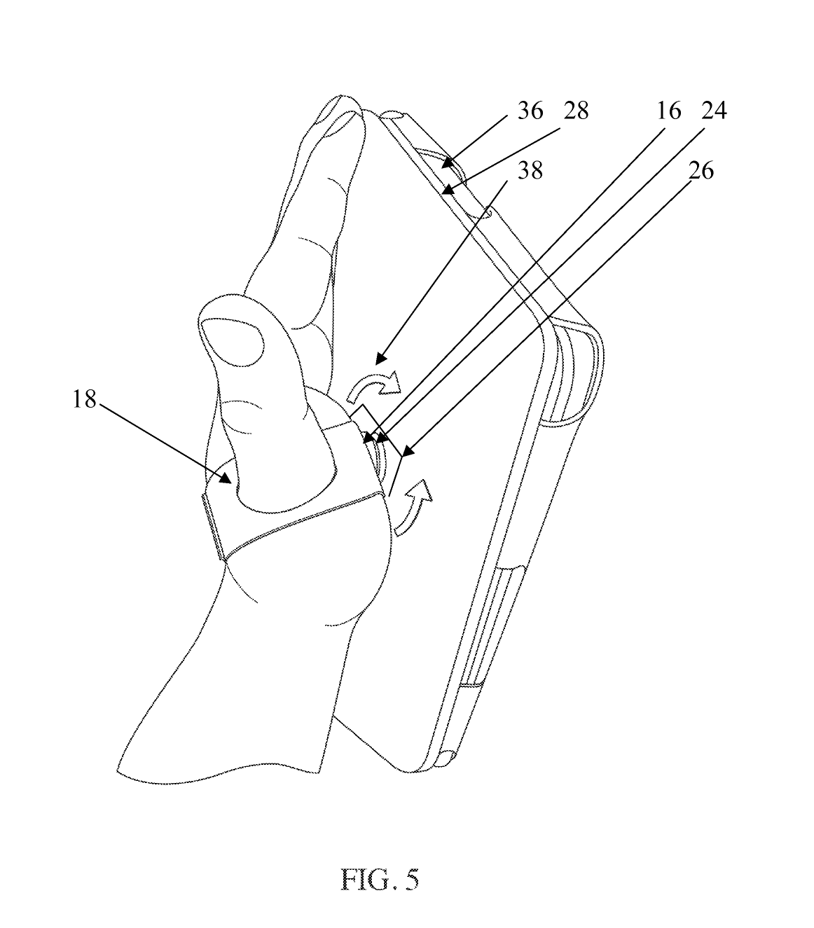

In order for the strap of either accessory 10, 30 to attach to a Tablet or other such device 36 (see FIG. 5), a 1″×1″ piece of square material 26 with a heavy duty adhesive (non-magnetic) on one side and a male button snap 24 on the other will be used (see FIGS. 1-5). The user will affix the 1″×1″ square material 26 to the back of their device protective casing 28 using the extra strength adhesive (or, alternatively, to the device 36 itself). The user will then place the strap over hand with thumb inserted into the thumbhole 18 (see FIG. 5) and with the female button snap fastener 16 positioned in the middle of palm. The strap will then be tightened to desired position for comfort and stability.

Once the strap is in place, the female button snap fastener 16 will be snapped onto the male button snap fastener 24 (preferably affixed to the back of the device protective casing 28 with the square material 26). Since there are several types and sizes of portable touch screen devices, this invention will be universal and will attach to the back of the protective casing 28 of any such device or to the back of the device 36 itself.

Operation of some “apps” requires the device to go from landscape orientation to portrait orientation or a combination of both. The swivel motion which is possible with the use of the button snap fastener allows for free 360° rotation as reflected by the direction arrows 38 of FIG. 5.

The entire strap may be commercialized within a packaging that also contains the male button snap fastener and the material with adhesive backing.

In accordance with a further embodiment, the carrying aid may be in the form of a glove instead that lacks a closed thumb, i.e., it has a thumbhole instead for the thumb to protrude out. The glove has the female button snap fastener 16 in the middle of the palm. Such a glove may be more fashionable or effective than the strap, depending on the users' preference. The glove may have finger holes for each of the remaining four fingers to protrude through or may not. Preferably, the glove fits snugly onto the hand as would be the case for a tension glove.

What is claimed is:

1. A carrying aid for transporting and swiveling a portable touch screen device, comprising an accessory configured to wrap around a palm and back of a wearer's hand and having a thumbhole positioned and sized to permit a thumb to protrude through the thumbhole to retain the accessory wrapped around the palm and the back of the wearer's hand and allowing fingers of the wearer to grasp the portable touch screen device for transporting same, the accessory having a button snap fastener for mating with a complementary button snap fastener to permit swiveling of the portable touch screen device by 360 degree rotation about the palm of the wearer's hand.

2. The carrying aid of claim 1, wherein the accessory is an elongated strap with two free ends, the elongated strap being equipped with means for securing the two free ends of the elongated strap with each other.

3. The carrying aid of claim 2, wherein the means for securing includes a buckle and prong at one of the free ends and a series of holes in succession at the other of the free ends, each of the series of holes being smaller than the thumbhole.

4. The carrying aid of claim 2, wherein the means for securing includes hooks and loops engaging with each other.

5. The carrying aid of claim 1, further comprising the complementary button snap fastener.

6. The carrying aid of claim 5, wherein the button snap fastener is female and the complementary button snap fastener is male.

7. The carrying aid of claim 5, further comprising a material secured to the complementary button snap fastener, and an adhesive on a side of the material that faces away from the complementary snap fastener.

8. The carrying aid of claim 2, further comprising a packaging containing an entirety of the strap, the complementary button snap fastener, a material secured to the complementary button snap fastener and an adhesive on a side of the material that faces away from the complementary snap fastener.

9. A carrying aid for transporting a portable touch screen device, comprising an accessory configured to wrap around a palm and back of a wearer's hand and having a thumbhole positioned and sized to permit a thumb to protrude through the thumbhole to retain the accessory wrapped around the palm and the back of the wearer's hand and allowing fingers of the wearer to grasp the portable touch screen device for transporting same, the accessory being equipped with means for swiveling the portable touch screen device by 360 degree rotation about the palm of the wearer's hand while the accessory is wrapped around the palm and the back of the wearer's hand with the thumb protruding through the thumbhole.

10. The carrying aid of claim 9, wherein the accessory is an elongated strap with two free ends, the elongated strap being equipped with means for securing the two free ends of the elongated strap with each other.

11. The carrying aid of claim 10, wherein the means for securing includes a buckle and prong at one of the free ends and a series of holes in succession at the other of the free ends, each of the series of holes being smaller than the thumbhole.

12. The carrying aid of claim 10, wherein the means for securing includes hooks and loops engaging with each other.

13. The carrying aid of claim 9, wherein said means for swiveling includes mated button snap fasteners.
